(19) United States
(12) Patent Application Publication
(10) Pub. No.: US 2011/0086636 A1
(43) Pub. Date: Apr. 14, 2011

(54) SYSTEM AND METHOD FOR HOME CELLULAR NETWORKS

(75) Inventor: Tzu-Ming LIN, Jhubei City (TW)

(73) Assignee: Industrial Technology Research Institute

(21) Appl. No.: 12/576,327

(22) Filed: Oct. 9, 2009

(51) Int. Cl. H04W 48/20

(52) U.S. Cl. 455/434

(57) ABSTRACT

A method for wireless communication is provided. The method includes obtaining address information of a plurality of access points and determining physical position information of the plurality of access points based on the address information. The method also includes determining one or more zones covering the plurality of access points based on the physical position information and configuring a network self-organization scheme based on the one or more zones.

### TECHNICAL FIELD

The present invention relates to wireless communication systems and method used therefor.

### BACKGROUND

A home cellular network often includes a small cellular or wireless base station that provides services specifically to a customer's home, such as a femtocell. A femtocell generally is a small cellular base station, typically designed for use in residential or small business environments. The femtocell connects to the customer's service provider's network via a high-speed communication link and supports a small number of active mobile phones in a short-range or indoor setting. That is, the femtocell allows the service provider to extend service coverage indoors, especially where access would otherwise be limited or unavailable.

The femtocell may incorporate functionalities of a typical base station, but extends the base station functionalities to allow a simpler, self-contained deployment, and to provide an efficient choice for the service provider to improve both coverage and capacity, especially indoors.

However, because a femtocell uses the same frequency range as a typical base station (a macro cell) and operates within the coverage of the macro cell, interference between the macro cell and the femtocell may occur while both are transmitting. Further, when being deployed in close locations, such as floors of high-rise accommodations, different femtocells can create interference among themselves.

Technologies have been developed to address such interference issues. For example, certain technologies change a channel assignment of a femtocell to reuse time slots, or frequencies, to reduce interference, while certain other technologies apply self-organizing network (SON) techniques to avoid interference. However, there lacks a systematic approach on determining a desired scope or range of femtocells for performing channel assignments and/or SON techniques among the femtocells.

Methods and systems consistent with certain features of the disclosed embodiments address one or more of the problems set forth above.

### SUMMARY

An example in accordance with the present disclosure includes a method for wireless communication. The method includes obtaining address information of a plurality of access points and determining physical position information of the plurality of access points based on the address information. The method also includes determining one or more zones covering the plurality of access points based on the physical position information and configuring a network self-organization scheme based on the one or more zones.

Another example in accordance with the present disclosure includes a communication server for use in a wireless communication system. The wireless communication system includes a plurality of wireless access points configured to provide service to users. The communication server includes a database and a processor. Further, the processor is configured to obtain address information of the plurality of access points and store the address information in the database and to determine physical position information of the plurality of access points based on the address information. The processor is also configured to determine one or more zones covering the plurality of access points based on the physical position information and to configure a network self-organization scheme based on the one or more zones.

Another example in accordance with the present disclosure includes a method used in a communication server for a wireless communication system. The wireless communication system includes at least one wireless access point configured to provide service to a user. The method also includes receiving a request message from the user carried by the at least one wireless access point, and retrieving information associated with the user and the at least one wireless access point from a database, and the information includes physical position information. Further, the method includes determining one or more zones covering the at least one access point based on the physical position information, and configuring the at least one access point based on the one or more zones by sending one or more messages.

Another example in accordance with the present disclosure includes a method for configuring a plurality of access points within a coverage area. The method includes obtaining physical position information of the plurality of access points within the coverage area. The physical position information includes address information organized in a set of address elements of a hierarchical order. The method also includes creating a plurality of regions of the coverage area based on the set of address elements and address information of the plurality of access points, and determining one or more interference avoidance rules based on the plurality of regions. Further, the method includes configuring the plurality of access points based on the one or more interference avoidance rules.

It is to be understood that both the foregoing general description and the following detailed description are exemplary and explanatory only and are not restrictive of the invention, as claimed.

### BRIEF DESCRIPTION OF THE DRAWINGS

FIG. 1 shows an exemplary communication environment incorporating features consistent with embodiments of the present disclosed embodiments;

FIG. 2 shows an exemplary diagram of operations of femtocell access points consistent with disclosed embodiments;

FIG. 3 shows an exemplary control and configuration environment consistent with disclosed embodiments;

FIG. 4 shows an exemplary computer system consistent with disclosed embodiments;

FIG. 5 shows an exemplary operation process consistent with disclosed embodiments;

FIG. 6 shows an exemplary database hierarchical arrangement of femtocell access points consistent with disclosed embodiments;

FIG. 7 shows exemplary frequency usage groups for femtocell access points consistent with disclosed embodiments;

FIG. 8 shows other exemplary frequency usage groups for femtocell access points consistent with disclosed embodiments;

FIG. 9 shows exemplary different density areas consistent with disclosed embodiments;

FIG. 10A shows an exemplary zone configuration consistent with disclosed embodiments;

FIG. 10B shows another exemplary zone configuration consistent with disclosed embodiments;

FIG. 10C shows another exemplary zone configuration consistent with disclosed embodiments;

FIG. 11A shows an exemplary optimized zone configuration consistent with disclosed embodiments;

FIG. 11B shows another exemplary optimized zone configuration consistent with disclosed embodiments;

FIG. 11C shows another exemplary optimized zone configuration consistent with disclosed embodiments;

FIG. 12 shows an exemplary operational diagram consistent with disclosed embodiments; and

FIG. 13 shows an exemplary process for interference avoidance operation and/or frequency reuse operation consistent with disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

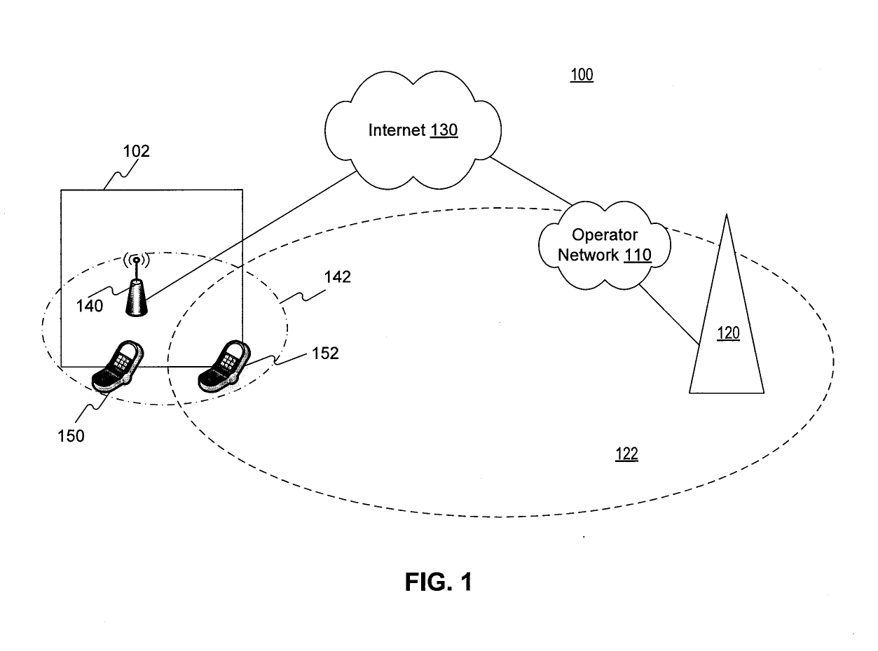

FIG. 1 shows an exemplary communication environment 100 incorporating features consistent with embodiments of the present disclosure. As shown in FIG. 1, communication environment 100 may include a home or business location 102, a wireless communication base station 120, a home cellular network base station 140, and mobile stations (MSs) 150 and 152. The numbers of base stations (BSs) and MSs are exemplary only and not intended to be limiting. Any numbers of BSs and MSs may be used, and other devices may be added.

An operator network 110 may be provided by a service provider operating BS 120 to perform operation, maintenance, and administration for BSs and MSs. Home cellular network BS 140 (e.g., a femtocell access point) may be provided in home or business location 102 to extend services provided by the service provider through operator network 110. Home cellular network BS 140 may be connected to operator network 110 through Internet 130 using any appropriate communication links, such as wired or wireless broadband access lines.

BS 120 may control a cell 122, and BS 140 may also control a coverage area 142. MSs 150 and 152 may communicate with BS 120 and/or BS 140 based on their locations. For example, MS 150 is shown in FIG. 1 as being located out of the service area covered by cell 122, but is within coverage area 142 and able to communicate with BS 140. As a further example, MS 152 is shown in FIG. 1 as being located within both cell 122 and coverage area 142 and is thereby able to communicate with BS 120 and BS 140. Further, MSs 150 and 152 and BSs 120 and 140 may be a part of a wireless communication network using various systems, e.g., code division multiple access (CDMA), wideband code division multiple access (WCDMA), orthogonal frequency division multiple access (OFDMA), wireless local area network (WLAN), worldwide interoperability for microwave access (WiMAX), etc.

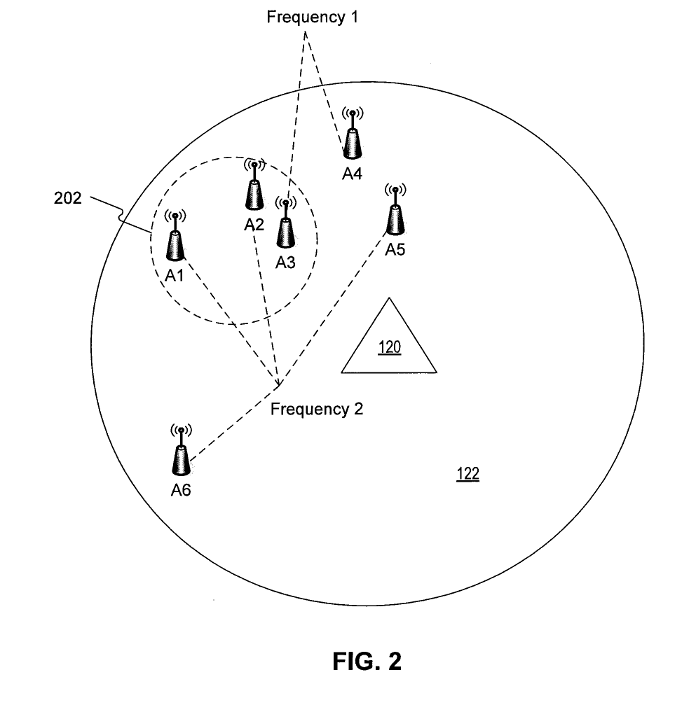

FIG. 2 shows an exemplary diagram of operations of femtocell access points consistent with disclosed embodiments. As shown in FIG. 2, a plurality of femtocell access points A1-A6 are provided along with cell 122 and BS 120. It is understood that FIG. 2 is used for illustrative purposes, and different types and numbers of access points may be included and different locations (e.g., inside or outside cell 122) may be used.

Femtocell access points A1-A6 may be provided by the service provider of BS 120. Femtocell access points A1-A6 may be configured and/or controlled by the service provider to perform frequency reuse, interference avoidance, and/or network self-organizing. Further, the frequency reuse, interference avoidance, and/or network self-organizing may be performed based on a zone. For example, a zone 202 may be used to include femtocell access points A1, A2, and A3, and other zones (not shown in FIG. 2) may be used to include other femtocells.

A zone, as used herein, refers to a scope or range of a group of access points or home cellular base station(s) (e.g., femtocell access points A1-A3). The zone may be defined physically or logically to reflect a group of access points or other network entities collectively performing network self-organizing, interference avoidance, and/or frequency reuse. The zone includes a geographical coverage and may also be two-dimensional or three-dimensional. Further, the zone may be fixed or may be dynamically changed in real-time during operation. Other information, however, may also be included in the zone.

Zone 202 may be determined based on various criteria, such as location, communication environment, self-organizing network mechanisms, and/or frequency or channel reuse schemes. Other methods of determination may also be used. In certain embodiments, zone 202 may be determined based on physical positions. A physical position, as used herein, refers to a geographic position along with localized physical characteristic parameters of a location. The geographic position may be represented by, for example, global position system coordinates, i.e., an altitude/longitude pair, or any other appropriate geographical notations. The localized physical characteristic parameters may include physical attributes of the location, such as floor number, floor height, building size, building direction, etc., and information about things surrounding the location, such as surrounding street width and direction, surrounding buildings, etc. Any appropriate physical attributes of the location may be included.

Based on zone 202, femtocells access points A1, A2, and A3 may perform network self-organizing upon a triggering event, such as when one of femtocell access points A1, A2, and A3 turns on from a power-off state, or an interference level among femtocell access points A1, A2, and A3 or between BS 120 and one or more of femtocell access points A1, A2, and A3 exceeds a threshold.

Further, based on zone 202 and/or physical position information of individual femtocell access points, frequency reuse may be implemented. For example, femtocell access points A1 and A2 in zone 202 may reuse frequency 2, femtocell access point A3 may reuse frequency 1 with femtocell access point A4 (outside zone 202). Femtocell access points A5 and A6 (outside zone 202) may reuse frequency 2 with femtocell access points A1 and A2. Other frequency reuse schemes may also be used. Interference avoidance may also be provided based on zone 202. For example, femtocells access points A1, A2, and A3 do not allocate the same channel within zone 202.

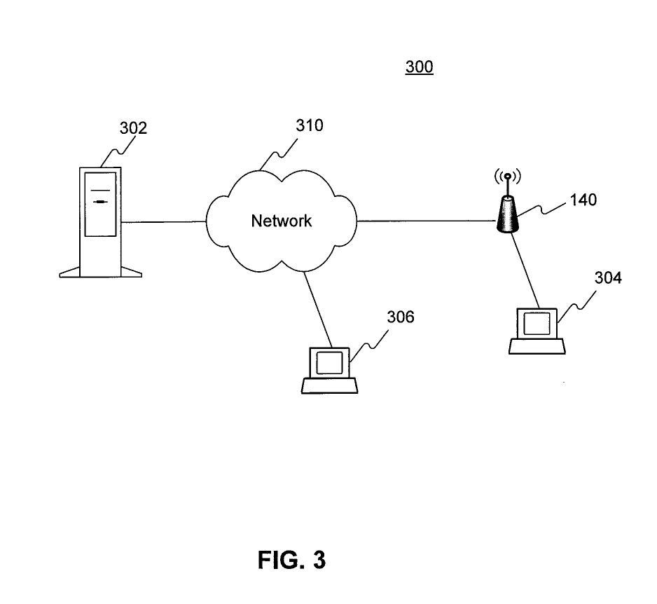

Zone determination, network self-organizing, interference avoidance, and frequency reuse of femtocell access points are controlled and/configured by the service provider of BS 120. FIG. 3 shows an exemplary control and configuration environment 300 consistent with disclosed embodiments.

As shown in FIG. 3, femtocell access point 140 communicates with a server 302 via a network 310. Server 302 may include any appropriate server computer provided by a service provider for configuring and controlling femtocell access point 140. In one embodiment, an operator or agent may be provided by the service provider to interactively configure and/or control femtocell access point 140 based on server 302.

A computer device 304 may be used by a user of femtocell access point 140 to communicate with server 302 and/or the operator/agent during the configuration and/or control process. Computer device 304 is configured to communicate with server 302 via femtocell access point 140. Further, the user may use a computer device 306 to communicate with server 302 and/or the operator/agent during the configuration and/or control process via network 310.

Computer device 304 and computer device 306 may include any appropriate computing devices, such as desktop computers, laptop computers, smartphones, and personal digital assistants (PDAs). Network 310 may include any appropriate private and/or public communication network for carrying communication between server 302 and other network entities.

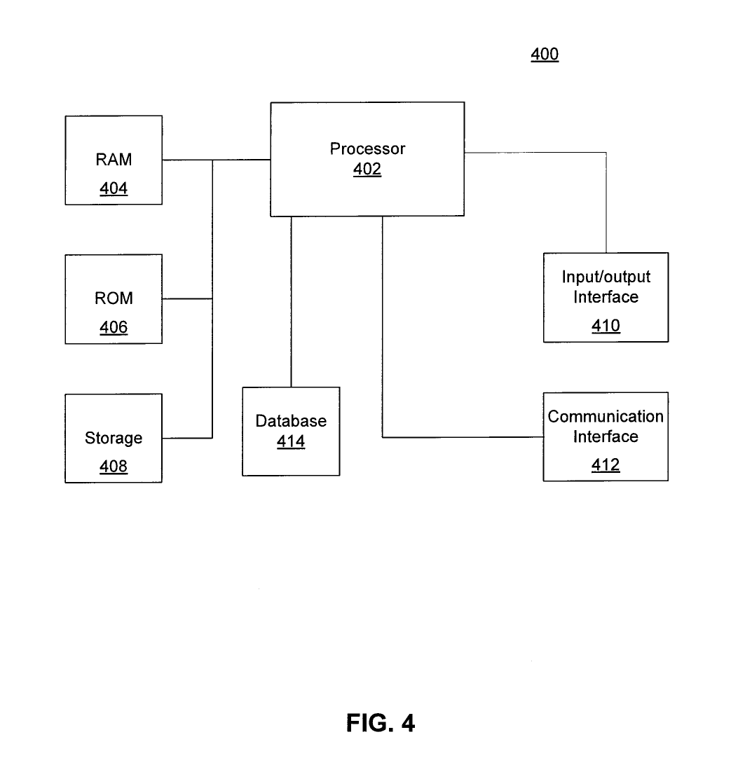

Server 302, computer device 304, computer device 306, and femtocell access point 140 may be implemented using one or more computer systems. FIG. 4 shows an exemplary computer system 400 which can be used for such implementation. As shown in FIG. 4, computer system 400 may include a processor 402, a random access memory (RAM) 404, a read-only memory (ROM) 406, a storage 408, an input/output interface 410, a communication interface 412, and a database 414. It is understood that the type and number of devices included in computer system 400 are exemplary only and not intended to be limiting. The number of listed devices may be changed, certain devices may be removed, and other devices may be added.

Processor 402 may include any appropriate type of general purpose microprocessor, digital signal processor, application specific integrated circuit (ASIC), or microcontroller. Processor 402 executes sequences of computer program instructions to perform various information processing functions and control functions. Processor 402 may be coupled to or may access other devices, such as transceivers, other processors, radio frequency (RF) devices, and/or antennas.

RAM 404 and ROM 406 may include any appropriate type of random access memory, read only memory, or flash memory. Storage 408 includes any appropriate type of mass storage provided to store any type of information that processor 402 may need to perform processing/functions. For example, storage 408 may include one or more hard disk devices, optical disk devices, floppy disk devices, and/or other storage devices to provide storage space.

Input/output interface 410 sends control and data signals to other devices from processor 402 and receives control and data signals sent from other devices to processor 402. Communication interface 412 provides communication connections to enable computer system 400 to exchange information with other systems via, for example, computer networks, such as the Internet. Further, database 414 includes any appropriate commercial or customized database for storing information associated with configuration and control of wireless networks.

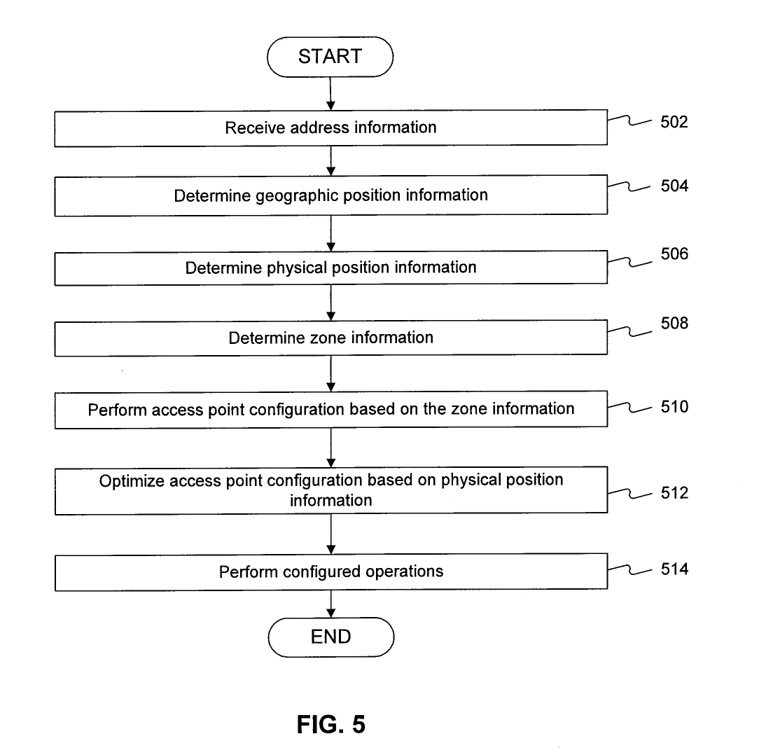

As explained previously, server 302 may be provided by the service provider to configure and control home cellular network base stations (or access points). FIG. 5 shows an exemplary operation process performed by server 302 and, more specifically, by processor 402.

As shown in FIG. 5, processor 402 receives address information of femtocell access points (502). Processor 402 may receive or obtain the address information from users of the femtocell access points by a registration process, in which users provide the address information of the femtocell access points. Processor 402 may also receive the address information automatically through the femtocell access points. Further, processor 402 may receive the address information from other computer systems or databases.

The address information may include any appropriate information about the locations of individual femtocell access points. For example, the address information may include personal addresses, corporate addresses, and/or community addresses, and the address may include information such as country, state, county, city, street, street number, building number, floor number, room/suite number, etc. Other information may also be included.

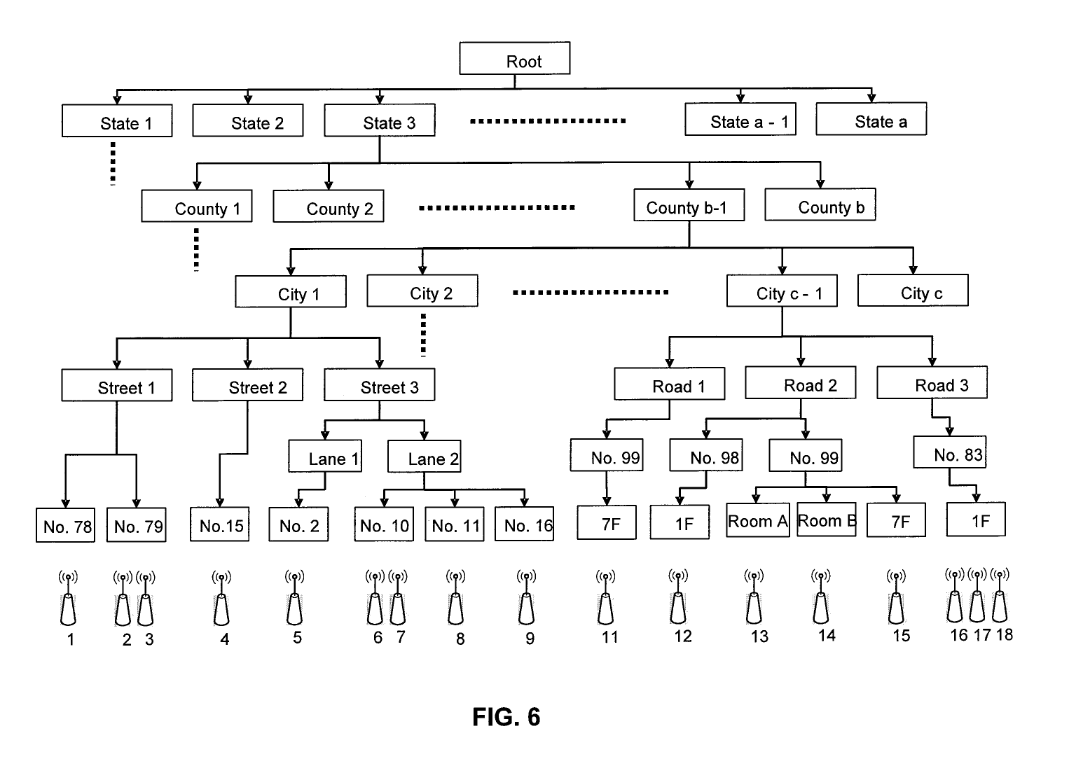

Further, processor 402 may process the address information of the femtocell access points and store the processed address information in a database, such as database 414. FIG. 6 shows an exemplary database hierarchical arrangement of the femtocell access points.

As shown FIG. 6, the address information for femtocell access points 1-18 is represented by a set of address elements and the address elements are arranged in a hierarchical order starting from ‘Root’ and going through ‘state’, ‘county’, ‘city’, ‘street’, ‘road’, ‘lane’, ‘number’, ‘floor’, and ‘room.’ Other arrangements may also be used. Further, more than one femtocell access point may be included in one address. For example, femtocell access points 2 and 3 belong to address “Root/State 3/County b-1/City 1/Street 1/No. 79” and femtocell access points 16, 17, and 18 belong to address “Root/State 3/County b-1/City c-1/Road 3/No. 83/1F.”

Returning to FIG. 5, after receiving the address information (502), processor 402 determines geographic position information of the femtocell access points (504). For example, processor 402 may determine the geographic position information based GPS mapping. That is, processor 402 may map the address information into a latitude and longitude pair representing an absolute location.

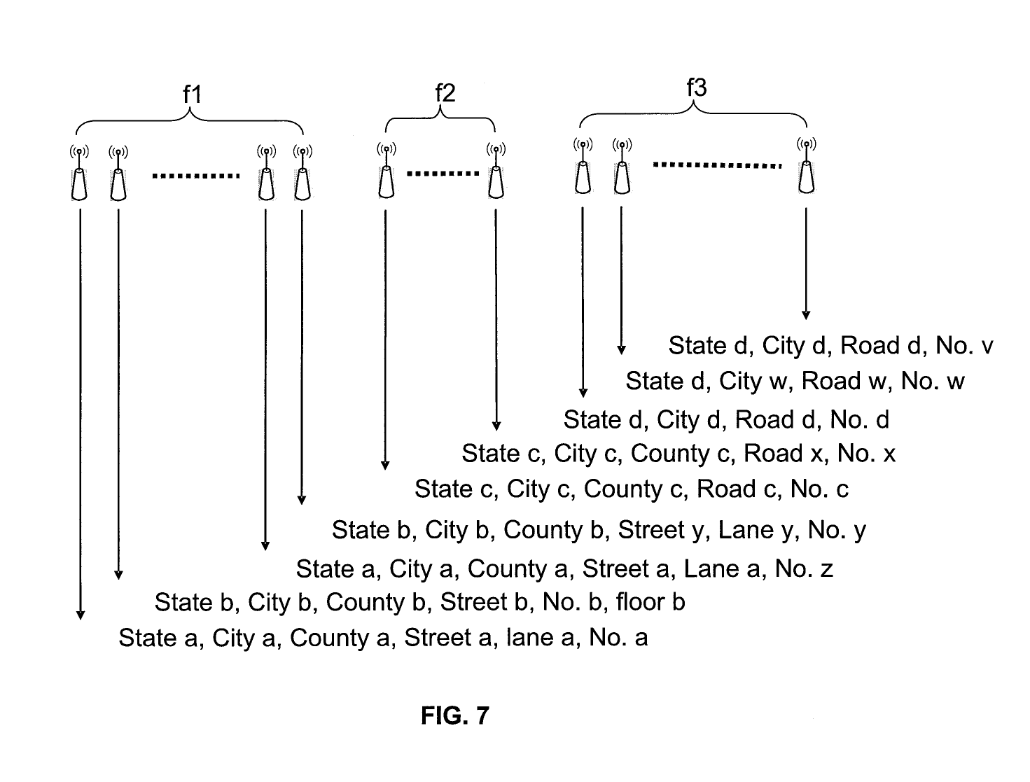

Processor 402 may also configure a frequency for a femtocell access point and may store the frequency information associated with the address information in the database. That is, processor 402 may use the address information in the database to determine a set of frequencies, each to be used by a plurality of the access points. FIG. 7 shows exemplary frequency usage groups for the femtocell access points consistent with the disclosed embodiments.

As shown in FIG. 7, three frequencies f1, f2, and f3 are used. Each frequency group includes a plurality of femtocell access points represented by the address information. Processor 402 may use any appropriate algorithm to determine the frequency groups based on the address information. Further, the same frequency may be used by femtocell access points with substantially the same address, e.g., femtocell access points on the same street or same building. The same frequency may also be used by femtocell access points with significantly different address, e.g., femtocell access points in a different state, county, city, etc.

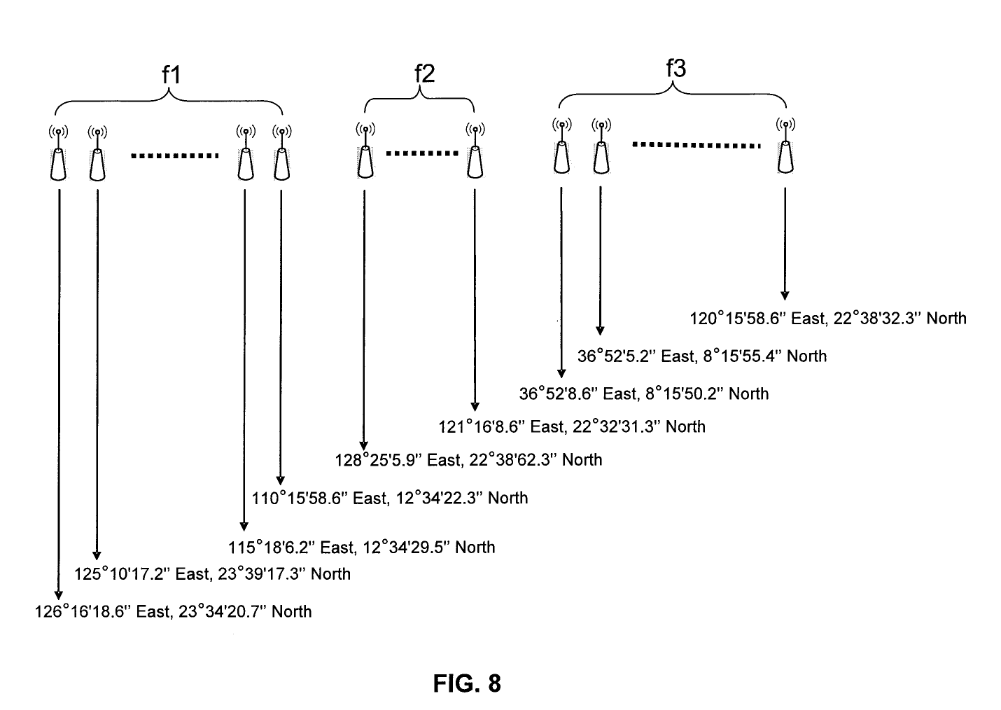

The frequency groups may also be determined based on other information, such as geographic position information. FIG. 8 shows other exemplary frequency usage groups for the femtocell access points based on geographic position information representation. As shown in FIG. 8, the femtocell access points correspond to the femtocell access points in FIG. 7, and the geographic locations of femtocell access points are each represented by a latitude and a longitude. The latitude and longitude values may be derived from a GPS mapping from the address information of the femtocell access points based on certain geographic information database. Other types of geographic information representations may, however, also be used.

After determining the geographic position (504), processor 402 determines physical position information of the femtocell access points (506). Processor 402 may determine the physical position information by associating localized physical characteristic parameters with the geographic position information based on the address information, the geographic position information, and/or other location based information. For example, processor 402 may associate physical attributes of the locations of the femtocell access points, such as floor number, floor height, building size, building direction, wall shielding effect, neighboring street width and direction, population and/or density of the location, etc., with the geographic information. Other attributes may also be used.

After determining the physical position information (506), processor 402 may determine zone information of the femtocell access points (508). Processor 402 may determine zone information of the femtocell access points based on various types of information, such as an area category (a type of an area), density information, GPS information, physical position information, and/or user information. Other information may also be used.

For example, processor 402 may determine area category and density information of the femtocell access points based on certain criteria. Density, as used herein, may refer to the number of address units within a coverage area, and is represented by F(Dᵢ, x), where i denotes a level of address units in the hierarchical arrangement of the address information of the femtocell access points, ‘Dᵢ’ refers to an average distance between two address unit at the same level i, and ‘x’ refers to the dimension of the coverage area. The value of T may be defined as city(1), county(2), street/road(3), lane(4), number(5), floor(6), etc. Other values may also be used. A different-size or same-size coverage area may be used to measure different levels of the address units.

For example, the density function F(D₅, 500 m) represents the number of address units or street numbers within a 500 m coverage area. If F(D₅, 500 m)>100, i.e., the total number of address units or street numbers within 500 m coverage is greater than 100, processor 402 may determine that the density is a high density, and that the coverage area belongs to an ‘urban’ area category; while if F(D₃, 2 km)<10, i.e., the total number of streets/roads within a 2 km coverage area is less than 10, processor 402 may determine that the density is a low density, and that the coverage area belongs to a ‘rural’ area category. Processor 402 may also determine a ‘suburban’ area category when a density is between the high density of the ‘urban’ area category and the low density of the ‘rural’ area category.

In one embodiment, processor 402 may set the distance of the ‘urban’ category as {D3, D4, D5, D6}={200 m, 50 m, 10 m, 3 m}, which means ‘urban’ density within, for example, 500 m coverage is {F(D₃, 500 m), F(D₄, 500 m), F(D₅, 500 m), F(D₆, 500 m),}={2.5, 10, 50, 167}. Further, the 500 m coverage may include different types of addresses, to be used independently or in combination. For example, the 500 m coverage may cover 2 streets with 2 lanes, 1 roads with 30 numbers, or 40 numbers with 100 floors, etc. For a ‘rural’ area category, processor 402 may set the distance as {D3, D5}={500 m, 50 m} and the 500 m coverage area may cover 1 road, or 10 numbers. Other values may also be used.

Processor 402 may also determine a distance between two different categories or zones based on the density, the average distance, and the address level. For example, processor 402 may determine the distance between a first category or zone of {D1, D2, D3, . . . Di} and a second category or zone of {D1′, D2′, D3′, . . . Di′}, as Distance=Σᵢ (Di-Di′), for all i, where ‘i’ is the address level and D is the distance explained previously. This distance may also be used to represent a distance between two access points or two addresses associated with the two access points.

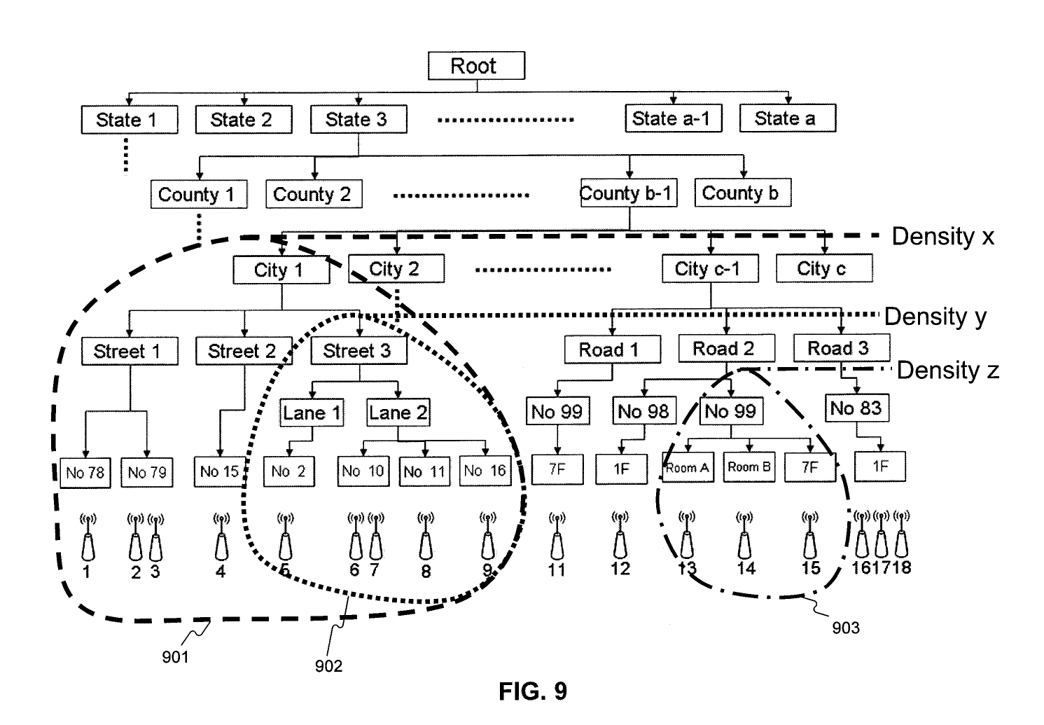

Further, when or during determining the zone information, processor 402 may analyze the address information of the femtocell access points previously obtained and/or stored in databases to create certain areas with corresponding densities. FIG. 9 shows exemplary different density areas.

As shown in FIG. 9, processor 402 may analyze the hierarchically arranged addresses and determine areas with certain densities. For example, processor 402 may determine an area 901 with a density ‘x’, an area 902 with a density ‘y’, and an area 903 with a density ‘z’. Other areas and densities may also be determined. Further, various relationships may exist among different density areas. For example, one density area may overlap with another density area, may include another density area, or may be completely separated from another density area.

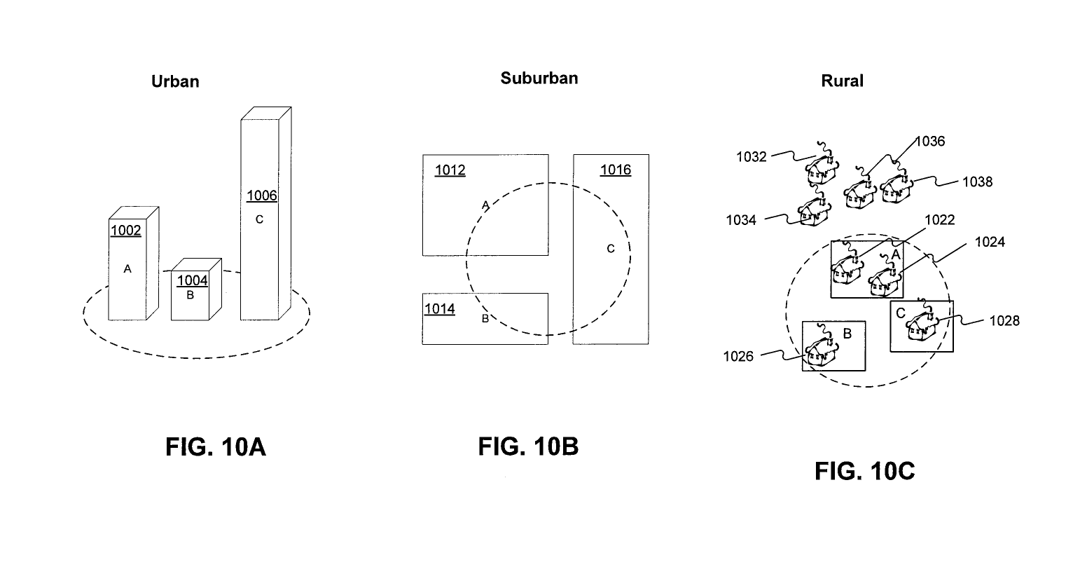

Processor 402 may further determine zones based on the various information previously mentioned. For example, processor 402 may first determine a scope of an initial zone based on address information and/or GPS information, such as a GPS zone. Further, processor 402 may look up the database to identify femtocell access points within the initial zone. After identifying the femtocell access points within the initial zone, processor 402 may apply other information, such as physical position information, to determine desired zones. FIGS. 10A, 10B, and 10C illustrate exemplary zone configurations. Thus, in certain embodiments, processor 402 may determine zones A, B, and C as shown in each of FIGS. 10A, 10B, and 10C. Also as shown in FIGS. 10A, 10B, and 10C, a dotted circle represents a GPS based zone without consideration of other types of information, such as density and/or physical position information.

Returning to FIG. 5, after determining the zone information (508), processor 402 performs access point configuration based on the zone information (510). For example, processor 402 may perform a self-organizing network configuration, interference avoidance, and spatial reuse (e.g., frequency use) based on the zones as shown in FIGS. 10A, 10B, and 10C.

FIG. 10A illustrates a zone configuration for an urban area. As shown in FIG. 10A, in the ‘urban’ area category, although buildings 1002, 1004, and 1006 are in the same GPS zone or initial zone, buildings 1002, 1004, and 1006 may be separated by using physical position information. Processor 402 may determine that buildings 1002, 1004, and 1006 are sufficiently separated by streets or spaces among buildings 1002, 1004, and 1006 such that buildings 1002, 1004, and 1006 may be configured into separate zones, e.g., building 1002 as zone A, building 1004 as zone B, and building 1006 as zone C.

FIG. 10B illustrates a zone configuration for a suburban area. As shown in FIG. 10B, in the ‘suburban’ area category, although blocks 1012, 1014, and 1016 do not fit in the same initial zone or GPS zone (or overlap with the GPS zone), blocks 1012, 1014, and 1016 may be separated by using physical position information. For example, processor 402 may determine that blocks 1012, 1014, and 1016 are sufficiently separated by streets or spaces among blocks 1012, 1014, and 1016 such that blocks 1012, 1014, and 1016 may be configured into separate zones, e.g., block 1012 as zone A, block 1014 as zone B, and block 1016 as zone C.

FIG. 10C illustrates a zone configuration for a rural area. As shown in FIG. 10C, in a ‘rural’ area category, although houses 1022, 1024, 1026, and 1028 fit in the same GPS zone or initial zone, houses 1022, 1024, 1026, and 1028 may be separated by using physical position information. As distances between houses are generally large in the ‘rural’ area category, processor 402 may determine that houses 1022, 1024, 1026, and 1028 are sufficiently separated by spaces among houses 1022, 1024, 1026, and 1028 such that houses 1022, 1024, 1026, and 1028 may be configured into separate zones, e.g., houses 1022 and 1024 as zone A, house 1026 as zone B, and house 1028 as zone C. Houses 1032, 1034, 1036, and 1038 are not included in zones A, B, and C.

After determining the separate zones A, B, and C as shown in FIGS. 10A, 10B, and 10C, for self-organizing network configuration, processor 402 may configure the femtocell access points within separate zones A, B, and C as separate self-organizing networks (510). For interference avoidance, processor 402 may configure the femtocell access points within separate zones A, B, and C such that zones A, B, and C cannot allocate the same channel or channels to avoid interference among these zones. For spatial/frequency reuse, processor 402 may configure the femtocell access points within separate zones A, B, and C such that zones A, B, and C can reuse the spatial resource/frequencies between zones.

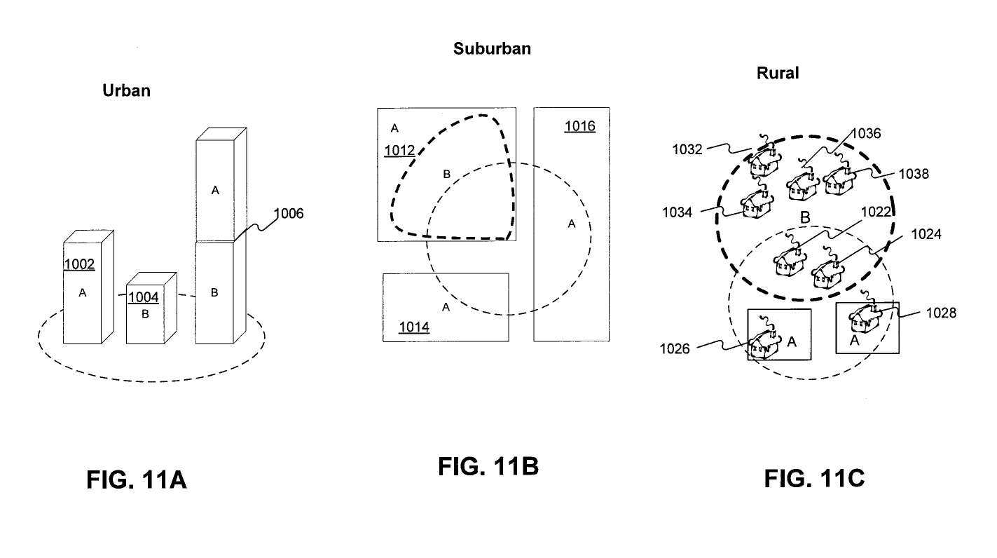

After performing access point configuration (510), processor 402 optionally optimizes access point configuration based on physical position information (512). FIGS. 11A, 11B, and 11C show exemplary optimized zones corresponding to zones in FIGS. 10A, 10B, and 10C, respectively.

As shown in FIG. 11A, processor 402 may consider floor information and/or street information to determine that two zones should be established. Processor 402 may configure zone A to include building 1002 and upper floors of building 1006, and configure zone B to include building 1004 and lower floors of building 1006, and do away with zone C. Other zone configuration and physical position information may also be used.

Also, as shown in FIG. 11B, processor 402 may consider density information and/or street information to determine that two zones should be established. Processor 402 may configure zone B to include a special area in block 1012, and configure zone A to include blocks 1014, 1016, and a remaining portion of block 1012 that is not covered by zone B. Other zone configuration and physical position information may also be used.

Further, as shown in FIG. 11C, processor 402 may consider density information and/or address information to determine that the center of the GPS zone should be shifted forward cover houses 1032, 1034, 1036, 1038 to increase efficiency for configuring the femtocell access points. Processor 402 may use the shifted GPS zone as the optimized zone for network self-organizing, interference avoidance, and spatial/frequency reuse, etc.

Returning to FIG. 5, after optionally optimizing the access point configuration (512), processor 402 performs configured operations (514). For example, a network self-organizing event may be triggered in a configured zone, such as a femtocell access point within the zone is turned on, or an interference level exceeds a threshold, and the femtocell access points within the zone perform self-organizing actions. Processor 402 may store such information and receive from and send to the femtocell access points any appropriate information within the zone to complete the self-organizing steps. Processor 402 may also perform or cause the femtocell access point to perform other operations, such as interference avoidance and spatial/frequency reuse. Other operations may also be performed.

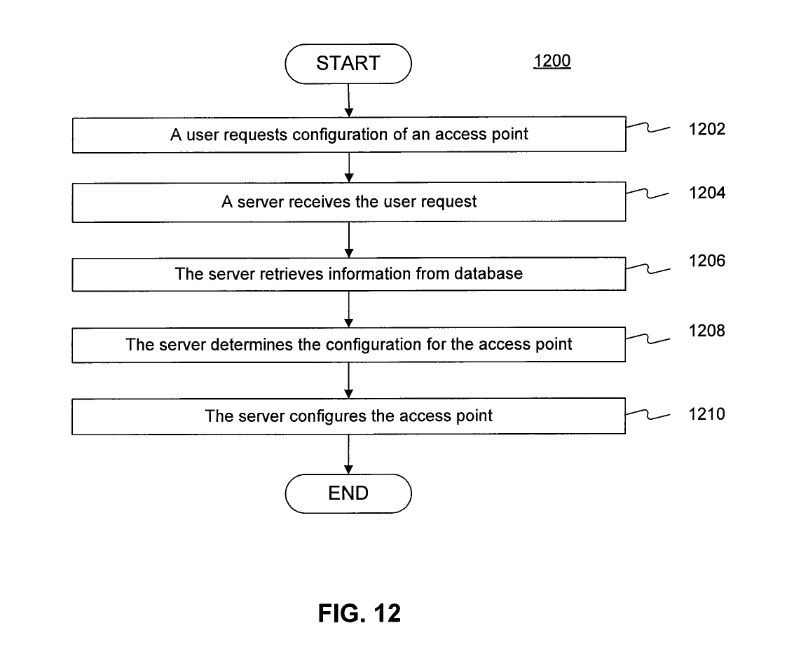

FIG. 12 shows an exemplary operational diagram 1200 corresponding to the system illustrated in FIG. 3. As shown in FIG. 12, a user requests configuration of an femtocell access point (e.g., femtocell access point 140 in FIG. 3) (1202). The user may request configuration when the user installs a new femtocell access point or reconfigures an existing femtocell access point. The user may request configuration via any appropriate user device, such as computer device 304 shown in FIG. 3, or directly through femtocell access point 140. Further, the user request may be carried by one or more messages from computer device 304 or femtocell access point 140 to a server (e.g., server 302 in FIG. 3) owned by a network operator to which the user belongs.

After the user, via computer device 304 or femtocell access point 140, sends the request message(s) to server 302 (1202), server 302 receives the user request message (1204). Server 302 may process the user request message and determine to accept the user request. Server 302 may receive and process the user request automatically or under direction of an operator, who may interact with server 302 using graphic user interfaces (GUIs).

Further, server 302 retrieves any appropriate information from a database (1206). The database may contain information about the user, computer device 304, or femtocell access point 140, etc. For example, the database may contain address information of the user, user location and other user data, femtocell access point 140 location and related data, physical position information of the femtocell access point 140, network configurations, and/or other operational parameters.

After retrieving the information (1206), server 302 determines configuration for femtocell access point 140 (1208). For example, server 302 may perform part of or entire operation process shown in FIG. 5 to determine configuration parameters for desired operation of femtocell access point 140.

Further, server 302 may configure femtocell access point 140 (1210). Server 302 may configure femtocell access point 140 by sending one or more messages to femtocell access point 140 or to computer device 304. Server 302 may also send one or more message to the user and the user may configure femtocell access point 140 directly or through computer device 304. Any appropriate configurations may be performed by server 302.

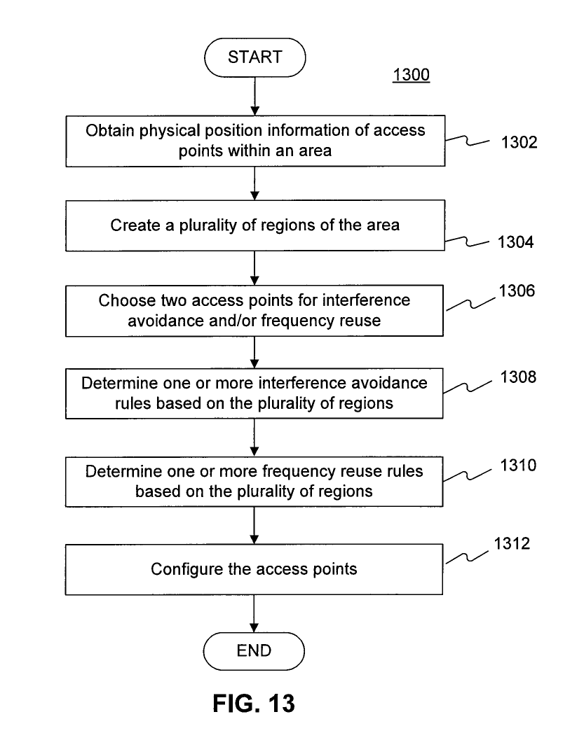

FIG. 13 shows an exemplary process 1300 for interference avoidance operation and/or spatial/frequency reuse operation performed by processor 402. As shown in FIG. 13, processor 402 may obtain physical position information of access points within a coverage area (1302). For example, processor 402 may obtain address information of the access points represented in a hierarchical sequence of address units, as explained previously. Further, processor 402 may create a plurality of regions based on the address and address units (1304).

Processor 402 may create the plurality of regions at a plurality of levels associated with the levels of the address units. For example, processor 402 may create a first level of large-size regions, a second level of middle-size regions, and a third level of small-size regions. More specifically, processor 402 may create the large-size regions based on address unit levels ‘state’, ‘county’, and ‘city’. That is, addresses with the same values of address units ‘state’, ‘county’, and ‘city’ are included in the same large-size region. Further, processor may create the middle-size regions based on address unit levels ‘street’, ‘road’, and ‘lane’, and the small-size regions based on address unit levels ‘number’, ‘floor’, and ‘room’. Addresses in a single large-size region with the same values of address units ‘street’, ‘road’, and ‘lane’ are included in the same middle-size region, and addresses in a single middle-size region with the same values of address units ‘number’, ‘floor’, and ‘room’ are included in the same small-size region. Other configurations, however, may also be used.

After creating the plurality of regions for the access points (1304), processor 202 chooses or accepts two access points for interference avoidance and/or frequency reuse (1306). For example, processor 402 may accept a request from a user to configure and perform the interference avoidance and/or frequency reuse between two or more neighboring access points, or processor 402 may automatically choose two access points to configure and perform the interference avoidance and/or frequency reuse based on certain criteria. Any number of access points may be configured.

Processor 402 may determine a set of rules for interference avoidance (1308) based on the regions. For example, if two access points belong to a same small-size region of a same middle-size region of a same large-size region, processor 402 assigns two different frequencies to the two access points to avoid interference. If two points belong to different small-size regions, but are included in a same middle-size region of a same large-size region, processor 402 may further estimate a distance between the two access points, and assigns two different frequencies to the two access points to avoid interference if the estimated distance is beyond a threshold for interference.

Further, if two access points belong to different small-size regions and different middle-size regions, but are included in a same large-size region, processor 402 may further determine whether there is any overlap between the middle-size regions. If there is overlap between the middle-size regions, processor 402 assigns two different frequencies to the two access points to avoid interference. Other methods may also be used.

Additionally or alternatively, processor 402 may determine a set of rules for frequency reuse based on the regions (1310). For example, if two access points belong to different large-size regions, processor 402 may assign a same frequency band to the two access points to reuse the same frequency band. If two access points belong to a same large-size region, but are included in different middle-size regions, processor 402 may further determine whether there is any overlap between the middle-size regions. If there is no overlap, processor 402 may assign a same frequency band to the two access points to reuse the same frequency band.

Further, if two access points belong to a same large-size region and a same middle-size region, but are included in different small-size regions, processor 402 may further estimate a distance between the two access points, and assigns a same frequency band to the two access points to reuse the same frequency band if the estimated distance is beyond a threshold for reuse. Other methods may also be used. Further, processor 402 may configure the access points based on the rules set forth above for interference avoidance and/or frequency reuse (1312).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for wireless communication, comprising:
obtaining address information of a plurality of access points;
determining physical position information of the plurality of access points based on the address information;
determining one or more zones covering the plurality of access points based on the physical position information; and
configuring the plurality of access points based on the one or more zones.

2. The method according to claim 1, wherein the address information is organized in a set of address elements and stored in a database of a server.

3. The method according to claim 1, wherein the physical position information is determined based on geographic position information and localized physical characteristic parameters associated with the address information.

4. The method according to claim 3, wherein the geographic position information is represented by an altitude and longitude pair.

5. The method according to claim 2, wherein the one or more zones are determined based on a density of a coverage area including the one or more zones.

6. The method according to claim 5, wherein a distance among the plurality of access points is determined based on the address information and the density of the coverage area including the one or more zones.

7. The method according to claim 1, wherein the determining one or more zones further includes:
determining a first zone based on geographic information of the access points; and
determining the one or more zones based on the first zone and the physical position information.

8. The method according to claim 1, further comprising:
configuring a network self-organization scheme based on the one or more zones.

9. The method according to claim 1, further comprising:
configuring an interference avoidance scheme based on the one or more zones.

10. The method according to claim 7, wherein the one or more zones allocate a same channel to avoid interference among the one or more zones.

11. The method according to claim 1, further comprising:
configuring a frequency reuse scheme based on the one or more zones.

12. A communication server for use in a wireless communication system that includes a plurality of wireless access points configured to provide service to users, the communication server comprising:
a database; and
a processor, the processor being configured to:
obtain address information of the plurality of access points and store the address information in the database;
determine physical position information of the plurality of access points based on the address information;
determine one or more zones covering the plurality of access points based on the physical position information; and
configure the plurality of access points based on the one or more zones.

13. The communication system according to claim 12, wherein the address information is organized in a set of address elements and stored in the database.

14. The communication system according to claim 12, wherein the processor is further configured to determine physical position information based on geographic position information and localized physical characteristic parameters associated with the address information.

15. The communication system according to claim 14, wherein the geographic position information is represented by an altitude and longitude pair.

16. The communication system according to claim 13, wherein the processor is further configured to determine the one or more zones based on a density of a coverage area including the one or more zones.

17. The method according to claim 16, wherein a distance among the plurality of access points is determined based on the address information and the density of the coverage area including the one or more zones.

18. The communication system according to claim 12, wherein, to determine the one or more zones, the processor is further configured to:
determine a first zone based on geographic information of the access points; and
determine the one or more zones based on the first zone and the physical position information.

19. The communication system according to claim 12, wherein the processor is further configured to:
configure a network self-organization scheme based on the one or more zones.

20. The communication system according to claim 12, wherein the processor is further configured to:
configure an interference avoidance scheme based on the one or more zones.

21. The communication system according to claim 20, wherein the one or more zones allocate a same channel to avoid interference among the one or more zones.

22. The communication system according to claim 12, wherein the processor is further configured to:
configure a frequency reuse scheme based on the one or more zones.

23. A method used in a communication server for a wireless communication system that includes at least one wireless access point configured to provide service to a user, the method comprising:
receiving a request message from the user carried by the at least one wireless access point;
retrieving information associated with the user and the at least one wireless access point from a database, the information including physical position information;
determining one or more zones covering the at least one access point based on the physical position information; and
configuring the at least one access point based on the one or more zones by sending one or more messages.

24. A method for configuring a plurality of access points within a coverage area, comprising:
obtaining physical position information of the plurality of access points within the coverage area, the physical position information including address information organized in a set of address elements;
creating a plurality of regions of the coverage area based on the set of address elements and address information of the plurality of access points;
determining one or more interference avoidance rules or one or more frequency reuse rules based on the plurality of regions; and
configuring the plurality of access points based on the one or more interference avoidance rules or the one or more frequency reuse rules.
